(19) United States
(12) Patent Application Publication
(10) Pub. No.: US 2009/0241059 A1
(43) Pub. Date: Sep. 24, 2009

(54) EVENT DRIVEN SMOOTH PANNING IN A COMPUTER ACCESSIBILITY APPLICATION

(76) Inventors: Scott David Moore, Manchester Center, VT (US); Timothy John Lalor, Manchester Center, VT (US); Frederick Lloyd Lichtenfels, III, Manchester Center, VT (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/052,506

(22) Filed: Mar. 20, 2008

(51) Int. Cl. G06F 3/048

(52) U.S. Cl. 715/800

(57) ABSTRACT

A method for facilitating accessibility of a computer system is described. A dynamic image, which is associated with the video output of the computer system, is displayed on the computer system's monitor. Once the computer system detects an event from the computer system, wherein the event causes a magnified area of the dynamic image to change from a current location in the dynamic image, the computer system determines a preferred location in the dynamic image based on the event. Based on the preferred location, the computer system generates a path from the current location to the preferred location, wherein the path includes a plurality of locations, which include the current location, the preferred location and a plurality of intermediate locations. Following the generation of the path, magnified areas associated with each viewing location in the path are displayed on the computer system's monitor in succession. Other embodiments are also described and claimed.

### BACKGROUND

An embodiment of the invention generally relates to computer accessibility tools which improve a visually impaired user's ability to view the contents of a digital display.

Modern computer systems provide user interfaces with high resolutions and the ability to navigate amongst numerous windows and applications. This trend toward greater detail and more access to information resources is viewed by many as a positive movement in favor of efficiency and productivity. However, to individuals with diminished eyesight, these features often hinder their ability to work effectively on a computer system. As a result of their ocular impairments, higher resolutions make it hard for these users to view the small objects on the computer system's monitor. The ever expanding reach of computers into homes and workplaces requires that users are able to effectively view information on computer systems.

Several applications are available which seek to aid visually impaired users to use their computers. The ZoomText magnifier is one such application that is produced by Ai Squared of Manchester Center, Vt. ZoomText magnifier is a user installed application which aids visually impaired users by digitally magnifying sections of the computer system's screen. The information on the screen is presented to the user at a user adjustable magnification level. Magnification is performed by capturing rendered data, which is destined for the computer monitor, and re-rendering this data such that it is scaled up. This magnified data is displayed to the end user by inserting the re-rendered data back into the display stream. As the user navigates the screen with the mouse or other navigational tool, the magnified section of the screen follows. Areas of the screen which are outside of the magnified view can be magnified by moving the cursor to the corresponding edge of the magnified view. The magnified view moves to the new location and magnified section of the screen is displayed on the computer system's monitor in lock step with movement of the mouse. Thus, the user is able to magnify any section of the screen by simply moving the mouse to the appropriate section of the screen. The magnified screen allows users to more easily view and read information which would otherwise be too small to read or appreciate.

Application events and system events often change the focus of the computer system's screen. This means a different application may move from background to foreground, a different window may come to foreground, or to a new location in a previously focused application. Magnification tools, such as ZoomText magnifier, will move the magnified view to the new location of focus. These traditional magnification applications alter the location of the magnified view to the new location of focus in one, abrupt movement.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a diagram showing smooth panning by an accessibility application, in accordance with an embodiment of the invention.

FIG. 2 is a screenshot of the unmagnified screen in a computer system running a word processing application.

FIG. 3 is a screenshot of the computer system with the magnifier process running.

FIG. 4 is a screenshot of the computer system where the magnifier process has panned to a “Save As” dialog box.

FIG. 5 is a screenshot showing the dialog box while the magnifier process is not active.

FIG. 6 is a block diagram of a screen magnifier tool, in accordance with an embodiment of the invention.

FIG. 7 is a state diagram representing an example Event Flow, in accordance with an embodiment of the invention.

FIG. 8 is a state diagram representing an example Rendering Flow, in accordance with an embodiment of the invention.

### DETAILED DESCRIPTION

An embodiment of the invention is directed to smoothly panning or moving a magnified view in a computer system, as driven by an event in the system. Moving from one location to another by simply bringing the new portion of the screen into view creates a herky-jerky motion. Rather than jumping from one screen location to another in response to an event, transitioning from one area of a screen to another provides a more fluid movement. This allows the user of a magnification process 112 to follow the content of the location change and acquire a sense of the direction of the event.

In one embodiment, the magnification process 112 is an application program that once installed in the computer system can magnify the entire screen by displaying portions of the screen within a viewing area that can be panned by the user (e.g., by movement of the mouse) to show any part of the entire screen, magnified by a user specified factor. Further, the magnification process 112 may magnify a new location on the screen based on an event independent of direct user input. The magnification process 112 may modify the apparent speed and path to the new location based on various parameters.

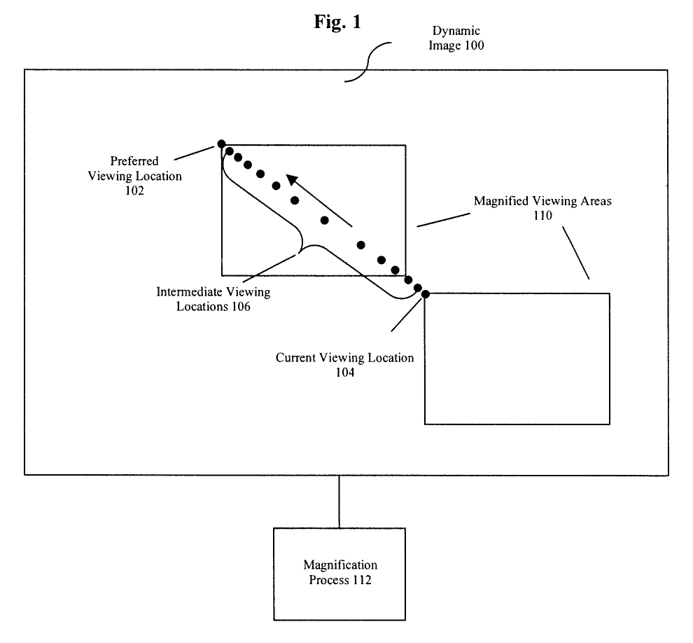

FIG. 1 illustrates the movement of a magnified view which is orchestrated by the magnification process 112, in accordance with an embodiment of the invention. The computer system may be a desktop computer, a notebook or laptop computer, a personal digital assistant (PDA), or any other computing device. The computer system contains a processing unit and a generic monitor which is capable of displaying a dynamic image 100 or screen produced by the processing unit. The computer system's monitor may be a standalone display device such as a dedicated flat panel display or a projector. Alternatively, the computer system's monitor may be integrated into the housing of the processing unit such as in a PDA or laptop computer.

The dynamic image or screen 100 may be a set of graphical and textual components which are continually updated by the processing unit as displayed by the monitor. The dynamic image 100 shows the logical desktop of the computer system, including windows of visible applications. The dynamic image 100 is refreshed by the processing unit as visible items on the desktop are updated or are introduced to the user. In one embodiment, the dynamic image 100 is represented as a bitmap with each pixel in the image 100 represented by a series of bits in the bitmap. For example, the color depth of the dynamic image 100 may be 24 bit. Thus, the associated bitmap in that case contains 24 bits for each pixel in the dynamic image 100. In another embodiment, the image is represented by vector graphics.

An event in the system may be an application event or a system event. Events are analyzed and processed by the magnification process 112. Events which change the focus of the computer system or its desktop to a location in an unfocused application, or to a new location in a focused application, are termed “events of interest.” Numerous events potentially can be events of interest. These events include, but are not limited to, a system event which requests input from the user, a user's request to perform a save operation on a document, a selection of an unfocused application by the system or the user, a prompt created by a system alert or application warning, etc.

Still referring to FIG. 1, following the capture of an event of interest, the magnification process 112 generates a path through the dynamic image 100. The path is based on the captured event of interest and user preferences. The path begins at a current viewing location 104 and terminates at a preferred viewing location 102. The path is comprised of several viewing locations including the current viewing location 104, the preferred viewing location 102 and a series of intermediate viewing locations 106. Each viewing location may be a multi-dimensional coordinate point or multi-dimensional area in the dynamic image 100, and may correspond to or is associated with a respective, individual magnified area 110 of the dynamic image 100. In one embodiment, each viewing location points to a top left corner of its associated magnified area 110. In other embodiments, the viewing location may point to the center of its associated magnified area 110.

Magnified areas 110 are multi-dimensional sections of the dynamic image 100 which are magnified according to user parameters. The real-time full screen magnification function used in an embodiment of the invention has the effect that any thing which is drawn or updated for display (by any applications running in the system) and that falls within the magnified area 110 is shown automatically as magnified. The user is able to select the level of magnification, based on a decimal multiplier for example. Further, the user may be able to select the portion of the computer system's monitor used to show the magnified areas 110. The magnified area 110 can be adjusted such that it is as large as the entire viewable area of the computer system's monitor. Alternatively, the magnified area 110 can be adjusted by the user such that it is smaller than full size of the computer system's monitor.

The current viewing location 104 corresponds to a reference point in the dynamic image 100 which the computer system or its desktop is presently focused upon. The preferred viewing location 102 corresponds to a point in the dynamic image 100 which the magnification process 112 has determined should become the current viewing location 104. The determination to change the current viewing location 104 in this way is performed by the magnification process 112 in response to a user or system generated event. Although the event which results in a change of the current viewing location 104 may be triggered by the user, the subsequent movement from the current viewing location 104 to the preferred viewing location 102 is performed entirely by the magnification process 112 independent of any direct input from the user. Once the event has been generated, control may shift entirely to the magnification process running in the computer system to generate and render the path onto the computer system's monitor.

The intermediate viewing locations 106 create a visibly smooth transition from the current viewing location 104 to the preferred viewing location 102. In one embodiment, the intermediate viewing locations 106 form a straight line between the two locations. In alternate embodiments, the intermediate viewing locations 106 are positioned to form a parabolic, hyperbolic, wavy, or other non-linear path. Alternate paths may be employed which use both linear and non-linear movement. For example, when a change in the preferred viewing location 104 occurs before arriving at the previously preferred location, both a linear and non-linear path can be used. A linear path would be a sudden shift in direction, while a non-linear path would trace an arc.

The user may designate the form of the path in these embodiments through the use of configuration parameters. The number of intermediate viewing locations 106 may also be user definable through the use of configuration parameters. In one embodiment, the number of intermediate viewing locations 106 is set by a user configurable speed scalar for example.

In one embodiment, the transition along the path is conducted using a panning effect which may be modified based on the number and positioning of the intermediate viewing locations 106. Setting a configuration parameter to include more intermediate viewing locations 106 in the path generates a visibly slow and smooth transition. Conversely, setting the configuration parameter to include fewer intermediate viewing locations 106 in the path generates a visibly quick and rough transition. Moreover, the viewing locations can be separated by differing distances in order to vary the apparent speed of the transition. In one embodiment, the distance between viewing location x and viewing location x+1 is less than the distance between viewing location x+1 and viewing location x+2. Arranging viewing locations in this manner creates the perception of accelerated movement between viewing locations in the path. The acceleration may occur over a period or a distance defined by the user. Thus, the viewing locations would initially be placed greater distances apart until a deceleration point or a time is reached. After the specified point or time is reached, the viewing locations may be placed closer together. By arranging viewing locations in this fashion, the movement between successive viewing locations initially rapidly accelerates until the specified time or point is reached and subsequently decelerates.

Various alternative methods of non-uniform movement may be selected by the user through configuration parameters. For example, when starting from the current viewing location, the magnification process 112 may accelerate through the path for a parameterized distance and thereafter keep a constant speed until the preferred viewing location is reached. This may be accomplished by the magnifier process increasing the distance between viewing locations until a parameterized distance is reached. Thereafter, the viewing locations are evenly spaced. Alternatively, the magnification process 112 may keep a constant rate of movement and then decelerate over a parameterized distance. This movement may be achieved by the magnification process 112 evenly spacing the viewing locations until a parameterized point is reached. Thereafter, the magnification process 112 decreases the distance between viewing locations. The non-linear movements described previously may be combined with these accelerating and decelerating options. For example, the magnification process 112 may accelerate through the first part of a curved path until it reaches the crescent of the arc. After reaching the crescent, the magnification process 112 may decelerate through the remainder of the arc. Further, although accelerating and decelerating are allowed options, they are not mandatory. For example, the viewing locations can be evenly spaced throughout the path. This even spacing would create a constant speed of movement for the magnification process 112 to traverse. Allowing the user the ability to define the method of traversing the path provides greater continuity to accommodate a user's ocular impairment. As described, the use of multiple viewing locations provides a visibly smooth path from the current viewing location 104 to the preferred viewing location 102. By providing a gradual transition, the user can clearly follow the movement between magnified areas 110.

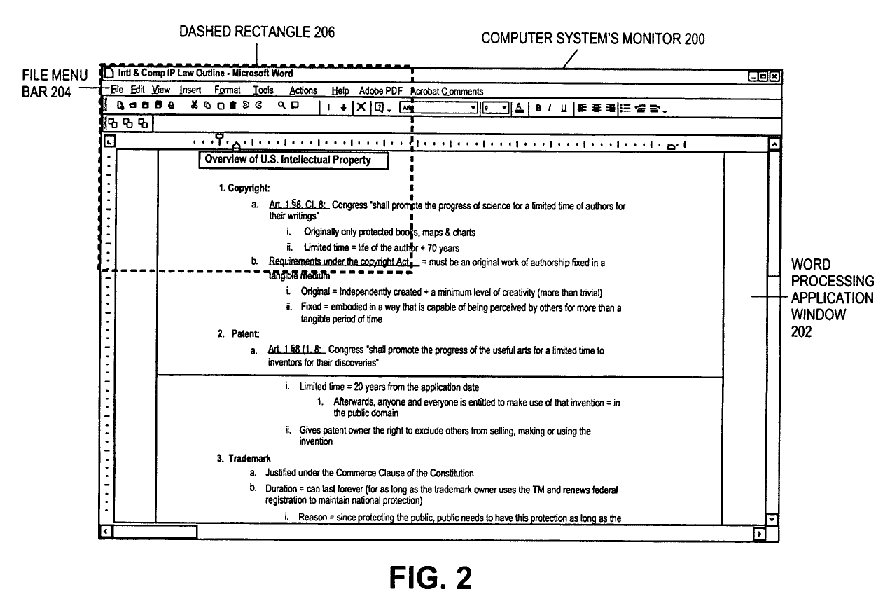

FIG. 2 is an example screenshot of a computer monitor produced by a computer system running a word processing application 202. The word processing application 202 includes a “File” menu bar 204 in the top left portion of the screen 200 which contains a “Save As” option. Magnification has not been applied yet; however a dashed rectangle 206 has been drawn on the screenshot to indicate the portion of the screen 200 which will be magnified when the magnification process 112 is activated.

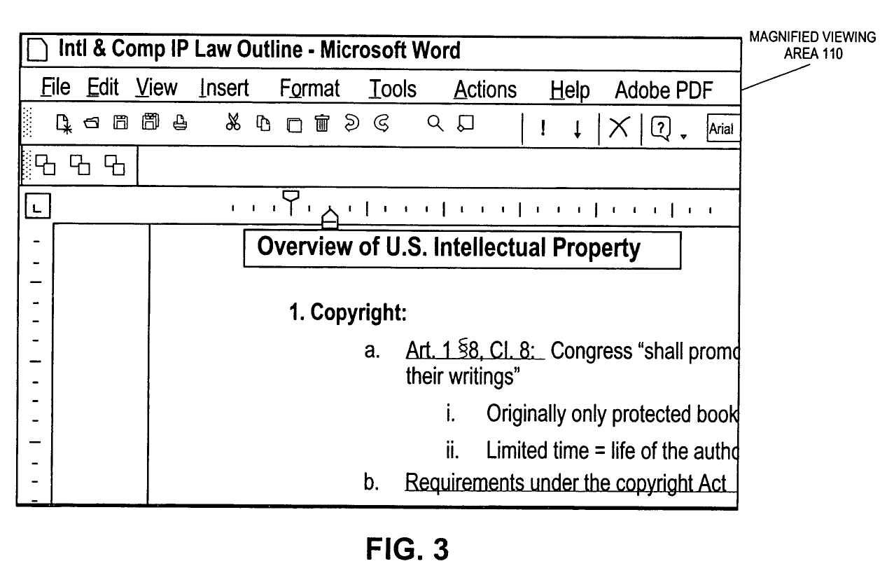

FIG. 3 is a screenshot with the magnification process 112 activated. The computer system is still running the word processing application 202, however, now a magnification process 112 has been initiated on the computer system. The magnification process 112 magnifies and displays the portion of the screen within the area of the rectangle 206.

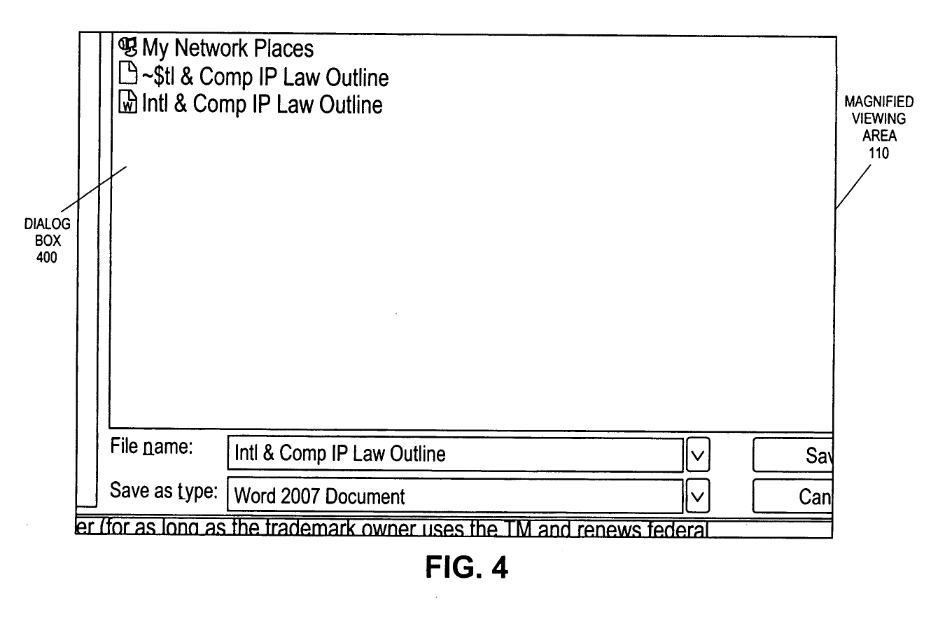

FIG. 4 is a screenshot of the computer monitor produced by a computer system running a word processing application 202 with the magnification process 112 running, immediately after the user has selected the “Save As” option from the “File” menu bar 204. For instance, the user may have navigated the mouse pointer to the menu bar 204 which then may have dropped down or otherwise expanded to display several File options, and then the user clicked on the “Save as” option. Note that at this point, the magnification process 112 has panned over to the area of the screen surrounding the mouse pointer. Selection of the “Save As” option by the user initiates the creation of a dialog box 400 to interact with the user. The creation of this dialog box 400 is an event which the magnification process 112 analyzes. Upon determining that this event is of interest, the magnification process 112 pans the view from the top left corner, as shown in FIG. 2 and FIG. 3; to the location of the dialog box 400 which was generated by the “Save As” command. The panning may be performed according to the process shown in FIG. 1. According to this procedure, the magnification process 112 determines a preferred viewing location 102 and the current viewing location 104 in the screen. According to these two locations on the screen 200, the magnification process 112 generates a path consisting of the current viewing location 104, a plurality of intermediate viewing locations 106 and the preferred viewing location 102. Subsequent to generation of these viewing locations, the magnification process 112 alters the view on the computer monitor by traversing the path and rendering the magnified areas 110 associated with each viewing location in the path. The rendered magnified areas 110 are displayed on the computer system's monitor in sequence. The displaying of the rendered magnified areas 110 in sequence creates a panning effect.

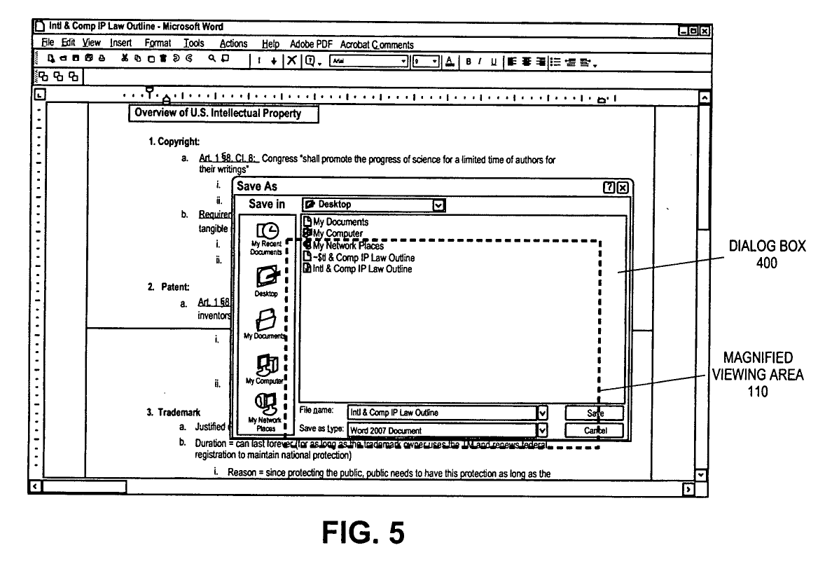

FIG. 5 is a screenshot of the computer system but with the magnification process 112 no longer active. As can be more clearly seen from FIG. 5, the magnification process 112 panned the magnified view from the upper left corner of the screen 200 to the “Save As” dialog box.

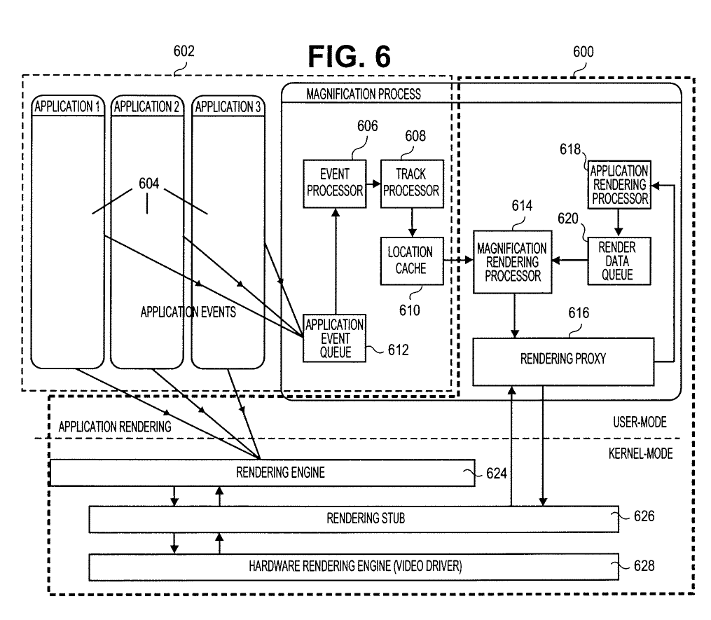

FIG. 6 illustrates one implementation of the smooth panning methodology described above. In one embodiment, the method and system described above can be implemented through the use of two streams: an Event Stream 600 and a Rendering Stream 602. The Rendering Stream 602 starts with applications 604 drawing their user interface on the desktop and ends with a magnified portion of the desktop being made visible to the user. The event stream 600 starts with a user-initiated or application-initiated change in state and ends with system generated visual feedback of bringing a new portion of the screen into view (and/or auditory feedback of speaking details of the state change).

### Rendering Stream 600

Application Rendering: Visible applications 604 typically utilize native system services, for example the Graphics Device Interface (GDI) in Microsoft Windows systems, to render their window on the desktop. This includes drawing of window area, window frames and borders, and title and menu bars. Primitives are available and enable applications to draw circles, rectangles, ellipses, and other shapes, as well as text in different fonts.

Rendering Engine: The Rendering Engine 624 manages the rendering of the various visible applications 604. It is responsible for making sure the proper window order is maintained on screen. For example, the Rendering Engine 624 ensures the active application is drawn on top of inactive applications. It also serves as a generic interface to the Hardware Rendering Engine 628. Applications 604 utilizing this interface are isolated from the differences in rendering hardware. In one embodiment, the GDI is the Rendering Engine 624.

Hardware Rendering Engine: The realization of all rendering happens in the Hardware Rendering Engine 628. Drawing actually manifests itself on the computer system's monitor in this layer which is hardware-dependent and can vary in capabilities. The capabilities of the Hardware Rendering Engine 628 are governed by several variables, including the amount of memory, acceleration support, shadowed pointers, etc.

Rendering Stub: The Rendering Stub 626 is inserted between the Rendering Engine 624 and the Hardware Rendering Engine 628. The Rendering Stub 626 is used to redirect rendering destined for the computer system's monitor, report both off-monitor and monitor-based rendering for later analysis, rendering the magnified areas 110, etc.

Magnification Process: The magnification process 112 is a structure which holds several software components used to generate the path and render the magnified areas 110.

Rendering Proxy: The Rendering Proxy 616 is contained within the magnification process 112. The Rendering Proxy 616 has several responsibilities, including querying the Rendering Stub 626 for reports of application and system rendering data, dispatching rendering data to the Application Rendering Processor 618, and forwarding requests from the Magnification Rendering Processor 614 to the Rendering Stub 626 to update the magnified areas 110 on the computer system's monitor.

Application Rendering Processor: The Application Rendering Processor 618 is contained within the magnification process 112. The Application Rendering Processor 618 aggregates the drawing done by all the visible applications and calculates what areas overlap with the visible magnified portion of the screen. The areas to be refreshed are stored in the Render Data Queue 620.

Render Data Queue: The Render Data Queue 620 is contained within the magnification process 112. The Render Data Queue 620 holds the areas of the screen that need to be refreshed on the computer system's monitor. It allows the actual magnified rendering to be decoupled from the application rendering stream. When the Magnification Rendering Processor 614 is ready to process data, it retrieves it from the Render Data Queue 620.

Magnification Rendering Processor: The Magnification Rendering Processor 614 is contained within the magnification process 112. The Magnification Rendering Processor 614 looks to the Render Data Queue 620 and the Location Cache 610 to determine what should be composed as magnified areas 110. The items in the Render Data Queue 620 inform the processor of the areas of the dynamic image 100 that have changed. The data in the Location Cache 610 enables the Magnification Rendering Processor 614 to calculate the portion of the dynamic image 100 that should be magnified and rendered to the computer system's monitor. Combining these data items, the Magnification Rendering Processor 614 composes the magnified areas 110 to be rendered to the computer system's monitor and requests the Rendering Stub 626 to realize the rendered magnified areas 110. In one embodiment, this realization is performed via the Rendering Proxy 616.

### Event Stream 602

Application Events: The applications 604 provide the stimulus for the application events. In general, applications generate events from either user action, such as clicking on a menu, button, or scrollbar, or from a change in internal state, such as the arrival of an email message or the completion of an item being downloaded.

Application Event Queue: The Application Event Queue 612 is contained within the magnification process 112. Application events are captured, packaged and inserted into the Application Event Queue 612 for retrieval by the Event Processor 606.

Event Processor: The Event Processor 606 is contained within the magnification process 112. The Event Processor 606 parses the data in the Application Event Queue 612 to determine which events are of interest. Events that are associated with a particular location of the screen are forwarded to the Track Processor 608. Events that are not of interest to the user, such as redundant or degenerate events, are not processed further.

Track Processor: The Track Processor 608 is contained within the magnification process 112. The Track Processor 608 combines the event type and event location from the Event Processor 606 with the user's settings to determine where in the dynamic image 100 the user should be viewing (the preferred viewing location 102). When a preferred viewing location 102 is determined, its coordinates are stored in the Location Cache 610.

Location Cache: The Location Cache 610 is contained within the magnification process 112. The Location Cache 610 stores the area of the screen with which the last event is associated. This data is used by the Magnification Rendering Processor 614 to determine the portion of the dynamic image 100 to display to the user.

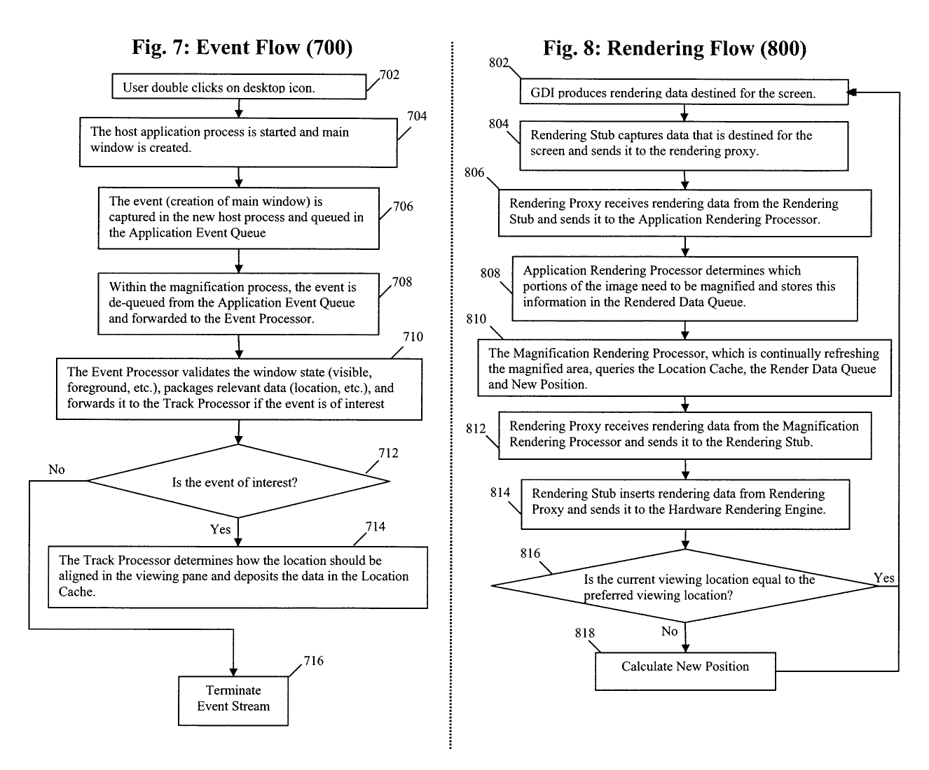

FIG. 7 and FIG. 8 show state diagrams using the implementation illustrated in FIG. 6 and described above. Two flows are provided: an Event Flow 700 and a Rendering Flow 800. Both flows 700, 800 run continually and independent of the state of the other flow.

The Event Flow 700 reacts to a user starting an application from a desktop icon. The Event Flow 700 begins after a user double clicks on a desktop icon (block 702). Double clicking the desktop icon creates a new host application process in which the window is created (block 704). After the event has been created, all subsequent operations are completely performed by the magnification process 112 without regard to user input. The event of “creating a new window” is captured and queued by the magnification process 112 in the Application Event Queue 612. The event is stored until the Event Processor 606 is ready to process the event (block 706). Upon de-queuing the event from the Application Event Queue 612 (block 708), the Event Processor 606 processes the event in order to generate characteristic data related to the event. The Event Processor 606 also determines if the event is “of interest” to the user (block 712). If the event is not “of interest” the flow terminates (block 716) and waits for another event. If the event is “of interest”, the characteristic data is packaged with the event and the package is sent to the Track Processor 608. The data packaged with the event includes the event type, the location of the window, etc. The Track Processor 608 analyzes the data package received from the Event Processor 606 and generates the preferred viewing location 102 (block 714). The preferred viewing location 102 is stored in the Location Cache 610. This completes the Event Flow 700 following the new window event.

In the Rendering Flow 800, the Rendering Engine 624 is continually producing rendering data for display on the computer system's monitor (block 802). This rendering data is captured by the Rendering Stub 626 which in-turn sends the rendering data to the Rendering Proxy 616 (block 804). Upon receiving the rendering data, the Rendering Proxy 616 forwards it to Application Rendering Processor 618 (block 806). The Application Rendering Processor 618 analyzes the data and determines which portions of the rendered image need to be altered and stores this information in the Render Data Queue 620 (block 808). The Magnification Rendering Processor 614 continually refreshes the magnified area 110 based on data from the Location Cache 610, the Render Data Queue 620, and the generated New Position by producing a rendered magnified area (block 810). After each refresh operation, the Magnification Rendering Processor 614 determines if the preferred viewing location 102 is equal to the current viewing location 104 (block 816). If the preferred viewing location 102 is not equal to the current viewing location 104, the New Position to be rendered by the Magnification Rendering Processor 614 is calculated (block 818). In one embodiment, the New Position is calculated by dividing the distance between the current viewing location 104 and the preferred viewing location 102 by a user configurable speed scalar. Alternatively, the New Position may be calculated from the user's settings for path shape, speed, acceleration, etc. These methods of calculating the New Position are not all inclusive and other ways of computing the New Position are possible. Regardless of the value of the current viewing location, the rendered data is sent to the Rendering Proxy 616 which forwards it to the Rendering Stub 626 (block 812). The Rendering Stub 626 inserts the rendered data in the Hardware Rendering Engine 628 which displays the contents to the computer system's monitor (block 814). The Rendering Stream 600 continues to capture data rendered by the Rendering Engine 624 and renders the data such that the current viewing location 104 is magnified.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The applications of the present invention have been described largely by reference to specific examples and in terms of particular allocations of functionality to certain hardware and/or software components. However, those of skill in the art will recognize that magnified displays can also be produced by software and hardware that distribute the functions of embodiments of this invention differently than herein described. Such variations and implementations are understood to be apprehended according to the following claims.

While certain exemplary embodiments have been described and shown in the accompanying drawings, it is not to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for facilitating accessibility of a computer system containing a monitor, which displays a magnified area of a dynamic image, the dynamic image is associated with video output of the computer system, the method comprising:
detecting an event from the computer system, wherein the event causes a magnified area of the dynamic image to change from a current viewing location in the dynamic image;
determining a preferred viewing location in the dynamic image based on the event;
generating a path from the current viewing location to the preferred viewing location, wherein the path includes a plurality of viewing locations, that include the current viewing location, the preferred viewing location and a plurality of intermediate viewing locations; and
displaying a magnified area at each of the plurality of viewing locations.

2. The method of claim 1, wherein a distance between the viewing locations in the path is variable and is based on user parameters.

3. The method of claim 2, wherein the distance between the viewing locations increases until a deceleration point has been reached, and then the distance between the viewing locations decreases until the preferred viewing location is reached.

4. The method of claim 1, further comprising:
determining a new preferred viewing location prior to viewing the preferred viewing location based on a new event, wherein the new event causes a magnified area of the dynamic image to change;
generating a new path based on the new preferred viewing location; and
displaying a magnified area at each of a plurality of new viewing locations in the new path.

5. The method of claim 1, wherein the plurality of viewing locations are positioned such that the path is non-linear.

6. The method of claim 2, wherein the distance between the viewing locations increases until a first point has been reached, then the distance between the viewing locations is constant until a second point is reached.

7. The method of claim 6, wherein the distance between the viewing locations decreases after the second point has been reached.

8. An article of manufacture comprising a machine readable medium having stored instructions that, when executed by a processor, perform a screen magnifier function in a computer system by
identifying an event from the computer system, wherein the event is to cause a magnified section to change;
determining a preferred reference point on a desktop based on the event, wherein the preferred reference point corresponds to a desired location in a focused application;
designating a plurality of reference points between a current reference point and the preferred reference point, wherein the current reference point corresponds to a location in a portion of the desktop currently being displayed by the magnified section; and
panning the magnified section from the current reference point to the preferred reference point according to the plurality of reference points, independent of direct input from a user.

9. The article of manufacture of claim 8, wherein panning comprises:
moving the magnified section to each of the plurality of reference points and subsequently to the preferred reference point.

10. The article of manufacture of claim 8, wherein the event is initiated by a user input.

11. The article of manufacture of claim 8, wherein the event is initiated by an application or a system incident.

12. The article of manufacture of claim 8, wherein a distance between the plurality of reference points increases until a deceleration point has been reached, and then the distance between the viewing locations decreases until the preferred reference point is reached.

13. A method for facilitating accessibility of a computer system containing a monitor, which displays a dynamic image, comprising:
displaying a magnified view of the dynamic image;
panning the magnified view as triggered by an event, wherein the panning subsequent to the event occurs independent from direct input from the user;
accelerating the panning for a first parameterized period; and
decelerating the panning after the first parameterized period for a second parameterized period.

14. A computer system containing an accessibility process to facilitate use of the computer system and its monitor by a visually impaired user, comprising:
an application event queue to store a captured event;
an event processor to generate a set of event data, including an event location on the monitor;
a track processor to determine if the captured event is of interest based on the set of event data and user settings;
a location cache to store the event data for an event of interest;
an application rendering processor to determine an area of the monitor which needs to be rendered;
a render data queue to store the areas of the monitor which need to be rendered;
a magnification rendering processor to generate a path from a current location on the monitor to the event location and render a plurality of magnified views associated with the path;
a rendering stub to replace drawing data sent to the monitor with the plurality of magnified views; and
a rendering proxy to receive drawing data from the rendering stub and send the plurality of magnified views to the rendering stub.

15. The accessibility process of claim 14, wherein the distance between the plurality of magnified views is variable and based on a configuration parameter.

16. The accessibility process of claim 14, wherein the distance between the plurality of magnified views increases over a first segment of the path, and then the distance between the magnified views decreases over a second segment of the path.

17. The accessibility process of claim 15, wherein the distance between the plurality of magnified views increases for a first period of time, and then the distance between the magnified views decreases over a second period of time.

18. The accessibility process of claim 14, wherein the magnified views are positioned such that the path is non-linear.
